(19) United States
(12) Patent Application Publication
(10) Pub. No.: US 2007/0219813 A1
(43) Pub. Date: Sep. 20, 2007

(54) Purchase option-based emergency supplies provisioning method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/421,694

(22) Filed: Jun. 1, 2006

Related U.S. Application Data
(63) Continuation-in-part of application No. 11/384,037, filed on Mar. 17, 2006.
(63) Continuation-in-part of application No. 11/394,350, filed on Mar. 30, 2006.
(63) Continuation-in-part of application No. 11/279,333, filed on Apr. 11, 2006.
(63) Continuation-in-part of application No. 11/379,929, filed on Apr. 24, 2006.
(63) Continuation-in-part of application No. 11/381,247, filed on May 2, 2006.
(63) Continuation-in-part of application No. 11/381,257, filed on May 2, 2006.
(63) Continuation-in-part of application No. 11/381,265, filed on May 2, 2006.
(63) Continuation-in-part of application No. 11/381,277, filed on May 2, 2006.
(63) Continuation-in-part of application No. 11/420,594, filed on May 26, 2006.

(51) Int. Cl. G06Q 10/00; G06Q 30/00

(52) U.S. Cl. 705/1

(57) ABSTRACT

A plurality of various emergency-related supplies are stockpiled (101) and consideration-based options are provided (102) to each of a plurality of entities (wherein at least some of these entities are geographically disparate with respect to one another) to provide a right to purchase portions of the plurality of various emergency-related supplies in the event of a catastrophic event. When such a catastrophic event is then at least likely to occur, affected ones of these entities are permitted (106) to exercise their respective option to purchase such emergency-related supplies to thereby facilitate meeting the emergency needs of such affected entities.

### RELATED APPLICATIONS

This application comprises a continuation-in-part of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265; and

SUBSCRIPTION-BASED CATASTROPHE-TRIGGERED RESCUE SERVICES FACILITATION METHOD AND APPARATUS as filed on May 2, 2006 and having application Ser. No. 11/381,277;

RESCUE CONTAINER METHOD AND APPARATUS as filed on May 26, 2006 and having application Ser. No. 11/420,594; the contents of which are fully incorporated herein by this reference.

### TECHNICAL FIELD

This invention relates generally to the provision of emergency supplies.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related actions that modem society requires in order to operate.

As powerful as the machinery of modem life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swath of a given civil entity. Any number of natural and/or human-caused events can greatly disrupt society's infrastructure and corresponding ability to provide one or more life-sustaining resources such as water, nutrition, shelter, and the like.

This situation exists in large measure due to the just-in-time nature of modern inventory and control schemes and practices. As but one example, studies have shown that a typical modern urban grocery store has but a few days worth of inventory on hand at any given time. Without a virtually constant re-supply stream, shelves would quickly go bare. A significant disruption to supply chains, then, can lead to a rapid depletion of available stock. This, in turn, can lead to critical shortages of necessary emergency supplies at the very moment when such supplies are most needed. The unpredictability with respect to what supplies may become limited in this regard can comprise a particularly troubling component of this problem.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a catastrophic event occurs. To a large extent one may reasonably argue that many governments have forsaken their responsibility to design, fund, implement, or even discuss an effective civil defense program capable of protecting large segments of their populations.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a catastrophic event. Therein, however, lies something of a conundrum.

On the one hand, modern governments typically do little to proactively ensure the bulk provisioning (let alone the comfort) of their citizens in the face of many or most catastrophic events. On the other hand, attempting to take responsible actions to reasonably ensure one's own safety and security can become, in and of itself, nearly a full-time avocation and leave little time to actually enjoy the conveniences and opportunities of modem life. Such individual actions may even be frowned upon by the greater part of society which has grown accustomed to and falsely secure with existing efficient just-in-time delivery systems that provide the illusion of plenty while undercutting the perception of risk.

### BRIEF DESCRIPTION OF THE DRAWINGS

The above needs are at least partially met through provision of the purchase option-based emergency supplies provisioning method described in the following detailed description, particularly when studied in conjunction with the drawing, wherein:

FIG. 1 comprises a flow diagram as configured in accordance with various embodiments of the invention.

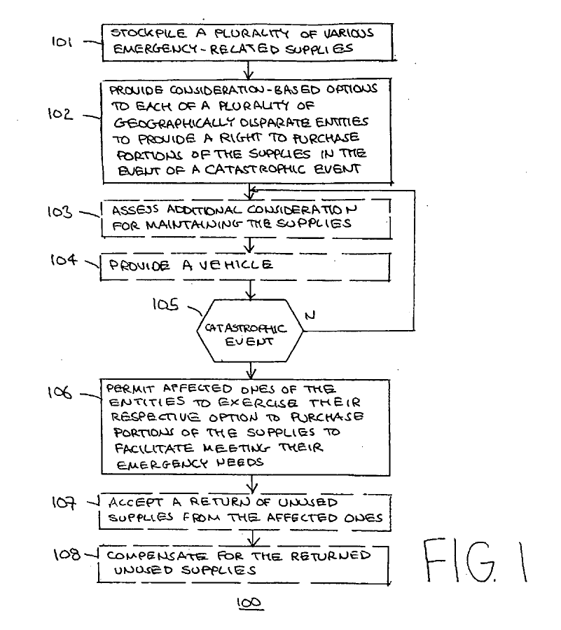

Skilled artisans will appreciate that common but well-understood elements that are useful or necessary in a commercially feasible embodiment are not necessarily depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a plurality of various emergency-related supplies are stockpiled and consideration-based options are provided to each of a plurality of entities (wherein at least some of these entities are geographically disparate with respect to one another) to provide a right to purchase portions of the plurality of various emergency-related supplies in the event of a catastrophic event. When such a catastrophic event is then at least likely to occur, affected ones of these entities are permitted to exercise their respective option to purchase such emergency-related supplies to thereby facilitate meeting the emergency needs of such affected entities.

These steps can be taken, for example, by a club to which such entities belong. Such steps can also be taken by other groups, businesses, partnerships, consortiums, franchisees, or the like as desired. So configured, an entity (such as an individual) can procure for themselves a right to purchase items on a relatively assured basis during a time when such items may be in short supply or possibly unavailable at any price. By providing a base of optionees that is at least somewhat geographically differentiated, it becomes considerably less likely that all of the optionees will have a need to access the stockpiled emergency-related supplies in a common time frame. As a result, it may not be necessary to stockpile sufficient supplies to fully provision the potential concurrent needs of all optionees.

By one approach the stockpiled emergency-related supplies can be selected to address the likely needs as pertain to a particular kind or category of catastrophic event. By another approach, however, the stockpiled emergency-related supplies can be selected to address the likely needs as pertain to a variety of differing kinds and/or categories of catastrophic events.

By these teachings a concerned entity can make an investment that will greatly increase their ability to procure emergency-related supplies in the face of a catastrophic event notwithstanding disruptions to ordinary supply chains and marketing outlets. These steps are facilitated without dependency upon governmental oversight, participation, or control. The particular emergency-related supplies provided can vary with the needs and requirements of the optionees themselves if desired. Importantly, these teachings permit a concerned entity to take important steps to achieve a considerably improved measure of security without having to effectively become a full-time survivalist; individuals can, in short, continue to enjoy their chosen vocations and standard of living knowing that, should a catastrophic event indeed be visited upon them, they will have extraordinary, concrete, and predictable access to emergency-related supplies. Such access, of course, can have an enormous impact with respect to whether a given entity successfully weathers and quickly recovers from a particular catastrophic event.

These and other benefits may become clearer upon making a thorough review and study of the following detailed description. Referring now to the drawing, these teachings provide generally for stockpiling 101 a plurality of various emergency-related supplies. These emergency-related supplies can be stored at a shared location or can be stored in a variety of separated locations. When storing such supplies in a plurality of locations, it may be useful to separate such locations by a sufficient distance to tend to ensure that a particular catastrophic event of concern will not likely simultaneously impact all such locations. This, in turn, can aid with ensuring the survival and subsequent availability of at least some of the emergency-related supplies.

Any suitable storage facility may be used for this purpose with examples comprising (but not being limited to) above ground man-made shelters, below ground or below water facilities (including purposefully excavated facilities, natural caverns, and so forth), and water borne facilities (such as barges and the like). In at least some application settings it may also be useful to provide for storing the stockpiled emergency-related supplies in a secure facility that is substantially hardened against anticipated catastrophic events. This can comprise use of a shelter that is, for example, protected by its design and construction against flooding, wind damage, impacts, or other undue environmental stresses as may correspond to such catastrophic events.

These emergency-related supplies can represent supplies of particular interest to the entities to be supplied (wherein the latter are described in more detail below). By one approach these emergency-related supplies can be selected to anticipate only a particular kind or category of catastrophic event (such as a particular weather event such as a hurricane or the like). By another approach these emergency-related supplies can be selected to anticipate each of a plurality of different catastrophic events (such as differing weather events, geological events, and so forth). In the latter case, of course, some emergency-related supplies may be applicable with respect to more than one kind or category of catastrophic event while other emergency-related supplies may be particularly targeted and selected for use in responding to the needs as typify a particular catastrophic event or category of event.

As used herein, “catastrophic event” will be understood to refer to an event that substantially and materially disrupts a society's local, regional, and/or national infrastructure and ability to provide in ordinary course for emergency-related supplies. Such a catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A catastrophic event can be occasioned by any of a wide variety of natural and/or human-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, a sudden and dramatic shift in the Earth's magnetic poles, and so forth), extreme space-based collisions (as with comets, large asteroids, and so forth), extreme environmental events (such as widespread uncontrolled fire or the like), global or regional pandemics, and economic dislocation as caused by these or other natural influences (such as might be due, for example, to an acute shortage of petroleum) to note but a few.

Examples of human-caused disasters capable of initiating a catastrophic event include both unintended events as well as intentional acts of war, terrorism, madness or the like. Examples of human-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, negligence that results in civil infrastructure failures (such as the bursting of a dam or the failure of a vehicular bridge to a relatively remote location), and so forth.

With the above caveats in mind, illustrative examples of emergency-related supplies might comprise any of a wide variety of consumable and/or non-consumable emergency-related supplies such as, but not limited to:
medical supplies (including consumable items such as dressings, medicines, vaccines, blood and plasma products, and so forth, as well as non-consumable items such as ventilators, wheel chairs, and so forth);
fuel supplies (including gasoline, diesel, natural gas, propane, charcoal, flammable gels, and so forth);
power source supplies (including batteries, solar cells, generators, and so forth);
nourishment supplies (including foods of various kinds such as fresh, canned, freeze-dried, frozen, refrigerated, raw, and processed food, vitamin supplements, and so forth);
hydration supplies (including potable water, water purification chemicals and/or apparatus, and other drinks or the like);
shelter supplies (including repair materials such as plywood sheets, framing lumber, nails or other securement mechanisms, tools, tarps, and so forth as well as stand-alone shelters such as tents, trailers, motorhomes, and other portable or stationary shelters);
transportation supplies (including vehicles suitable for use in a given usage scenario such as flat bottom watercraft or all terrain vehicles as well as spare parts, maintenance supplies, and so forth);
personal protection supplies (including face masks, ionizing radiation resistant coveralls, wearable dosimeters, self defense weaponry, and so forth);
breathable air supplies;
electromagnetic pulse recovery supplies (such as spare vehicular electronic control modules and so forth); and
sanitation supplies;
   to note but a few.

Acquisition of such items can be achieved through any of a variety of means. By one approach the items may be procured on the open market. By another approach the items may be purchased or otherwise acquired from third parties via private negotiations. By yet another approach the entity that provides and accepts these options may itself create (through manufacturing, farming, or the like) the items of interest. In some cases the acquired item may comprise a staple of ordinary commerce. In other cases the acquired item may be unique and/or proprietary to the acquiring/stockpiling entity.

This process 100 also provides for providing 102 consideration-based options to each of a plurality of entities (wherein at least some of the plurality of entities are geographically disparate from one another) to provide a right to purchase portions of the plurality of various emergency-related supplies in the event of a catastrophic event. (Those skilled in the art will understand that the expression “geographically disparate” refers to a sufficient distance such that the separated entities are not all likely to be impacted by a common shared catastrophic event. For example, when considering a catastrophic event such as a hurricane, the entire State of Florida might fairly be considered to be within a zone of ascertainable risk with respect to a given storm, while a more distant state, such as, for example, North Dakota or Kansas will most likely be outside the zone of risk for that same given storm.)

This option to provide a right to purchase portions of the stockpiled emergency-related supplies can be relatively unfettered if desired. By such an approach the affected entity would have the right to purchase any amount of the stockpiled supplies including the entire quantity of stockpiled emergency-related supplies. By another approach, this option can be limited in some fashion. For example, the affected entity may be limited to purchasing only up to a predetermined quantity of the plurality of emergency-related supplies. To illustrate, an affected entity might be limited to purchasing no more than 200 gallons of gasoline, 500 gallons of potable water, 100 sheets of plywood, and so forth.

This option can provide for specified pricing for such supplies or can, if desired, provide for floating pricing. By another approach the pricing can be constrained with respect to a lower limit, an upper limit, or both. By yet another approach the pricing can be pegged to another index or metric of choice. By one approach, this option can provide for pricing that increases with increasing volume for at least particular ones of the emergency-related supplies. For example, incremental increases with respect to the purchase of a given commodity such as an antiviral drug might require increased per-unit expenditures by the purchasing entity. This approach could be used, for example, to tend to discourage undue hoarding or attempts by an optionee to acquire scare items in order to locally sell for a relative profit.

By one approach, these options may be provided by, for example, a for-profit business. By another approach a not-for-profit business (such as a membership-based entity) may be the appropriate entity to offer such options.

As noted, these teachings provide for an option-based approach. As used herein, the term “option” shall be understood to refer to and encompass a variety of legal mechanisms. Some relevant examples include, but these teachings are not limited to, option mechanisms such as:

time-limited rights of exercise (as where an option provides exercise rights for a specific period of time, such as one year, in exchange for a corresponding series of payments);

event-limited rights of exercise (as where an option provides exercise rights during the life of a given optionee based upon an up-front payment in full and where those exercise rights terminate upon the death of the optionee or where, for example, a company purchases an option for a key employee and those corresponding option rights terminate when and if that key employee leaves the employment of that company);

inheritable rights of exercising the option (as may occur when the option, by its own terms and conditions, provides a right of exercise that extends past the death of a named optionee and further allows for testate and/or intestate transfer to an heir);

rights of exercise predicated upon a series of periodic payments (as where an option provides exercise rights during, for example, predetermined periods of time on a periodic basis as where an option requires month-by-month payments to gain corresponding month-by-month exercise rights);

rights of exercise predicated upon a one-time payment (as may occur when an optionee makes a single payment to obtain a time-based or event-based duration of option rights or, if desired, when a single payment serves to acquire a perpetual right of exercise that may be retained, transferred, inherited, or the like);

non-transferable rights (as may occur when the option, by its terms and conditions, prohibits transfer of the option right from a first named optionee to another);

transferable rights (as may occur when the option, by its terms and conditions, permits conditional or unconditional transfer of the option right from a first named optionee to another); and/or

membership-based rights (as may occur when the option, by its terms and conditions or otherwise, is part and partial to a membership interest such as, for example, a club-based membership such that the various optionee entities belong to that club; by this approach, for example, the corresponding club can effect the steps set forth herein).

If desired, a plurality of differentiated option opportunities can be offered in this regard. This plurality of differentiated option opportunities can correspond, for example, to providing access to differing emergency-related supplies. As but one very simple illustration in this regard, such option opportunities can differ from one another at least with respect to cost. This, in turn, provides optionee choice with respect to selecting a particular option that best meets their specific needs and/or budget limitations. For example, one option can provide for purchasing certain food supplies that, though nutritionally viable, are economically selected while another option might provide for food supplies that are more costly or that reflect, for example, a wider variety of choices.

These teachings readily encompass the notion of a given entity providing such a option for an optionee other than themselves. Such might occur, for example, when one family member procures such an option for one or more other family members. Another example would be for a company to obtain such options on behalf of named key employees, family members of such key employees, and so forth. Other examples no doubt exist.

This process 100 will accommodate, if desired, the optional assessment 103 of additional consideration in exchange for maintaining the stockpiled emergency-related supplies. The specifics of such maintenance, and hence the corresponding cost, will of course vary with respect to the nature of the supplies being maintained. Maintaining such supplies can comprise, for example, maintaining the utility of the stored supplies. This can comprise, for example, monitoring the usability of perishable items and replacing such items on a corresponding schedule. As another simple illustration this can comprise holding certain items in deep refrigeration or in other special storage conditions as may suit the proper maintenance of such items.

Stockpiling and/or maintaining the emergency-related supplies can also optionally comprise making adjustments to the stored items to reflect dynamically changing circumstances as occur during the option period. As one illustration, a new product may become available that is particularly useful in treating a particular infectious condition that may likely arise upon the occurrence of a particular kind of catastrophic event. In such a case, maintaining such resources can readily accommodate updating the acquired and stored items to include a supply of this new product. Accordingly, this step of making adjustments can readily comprise one or more of removing a particular one of the stored necessities (as when a better substitute becomes available, when the stored necessity itself is shown to be less effective for its intended purpose than was originally thought, and so forth), adding additional ones of the stored necessities (as when it becomes subsequently understood that more of a particular item is desirable to achieve a particular survival-related goal or purpose), adding at least one new stored necessity that is not already stored (as illustrated in the example provided above), and so forth.

If desired, this process 100 can also optionally provide for provision 104 of a vehicle. Such a vehicle could be used, for example, to deliver purchased portions of the emergency-related supplies to the affected optionees. Examples include, but are not limited to, air-borne vehicles (including fixed wing aircraft, helicopters, and hovercraft, to note but a few), terrestrial vehicles (including cars, buses, trucks, and trains, to note but a few), and water-borne vehicles (including boats and ships, submarines, and amphibious craft, again to note but a few relevant examples). In many cases the vehicle will comprise a piloted vehicle that requires an in-vehicle pilot/driver. These teachings would accommodate, however, a vehicle that comprise a pilotless vehicle (where the vehicle operates under the control of an automated control system, a remotely-located pilot, or some combination thereof).

In many cases the vehicle will comprise a terrestrial vehicle. In such a case it may be useful to configure and arrange the vehicle to be able to traverse off-road conditions. Such a capability may be usefull, for example, to successfully move past debris, stalled, blocked, or abandoned vehicles, impassable roadways, and so forth. This can comprise configuring the vehicle with a higher-than-normal suspension, a heavy-duty suspension, all-wheel drive, and so forth. This may also comprise configuring the vehicle's engine to operate even when partially or fully submerged (as may occur when fording a flooded area). Such accoutrements are known in the art and require no further elaboration here.

In many cases the vehicle will comprise a terrestrial vehicle that has a free-ranging capability to thereby freely navigate paved and unpaved surfaces of various kinds. In some cases, however, it may be useful to further configure and arrange the vehicle to also selectively travel compatibly on railroad tracks. This may comprise, for example, outfitting the vehicle with flanged wheels that can be selectively lowered to interact compatibly with a set of railroad tracks. Such apparatus is known in the art. So configured, the vehicle can selectively readily travel on railroad tracks which may, in a given time of need, comprise a relatively unblocked means of entering or passing through an impacted area.

In at least some cases it may be anticipated that the catastrophic event of concern and/or corresponding civil upheaval may involve, at least in part, unhealthy and/or dangerous ambient airborne contaminants. Examples include, but are not limited to, dangerous biological elements, dangerous chemical elements, dangerous radioactive elements, and so forth. These examples include both man-made and natural contaminants; for example, “chemical elements” can include both a man-made nerve gas and volcanic ash. By one approach, then, the vehicle can comprise one or more crew cabins that are substantially airtight. If desired, this can comprise configuring and arranging the crew cabin to selectively have positive air pressure when desired to aid in urging external airborne contaminants from entering the passenger cabin. Various ways and means are known in the art by which to provide positive air pressure in a contained space and therefore require no further detailed description here.

At least some catastrophic events may be accompanied by an electromagnetic pulse. Such a pulse can permanently damage many electrical circuits including, for example, the electronic engine controls for a vehicle. With this in mind, it may be desirable to harden at least the critical vulnerable systems of the vehicle to thereby substantially protect those systems against an electromagnetic pulse. Again, various ways and means of achieving such a result are known in the art and may be practiced here as desired.

As already alluded to above, the purpose of pre-positioning the vehicle is to ensure its availability to deliver emergency-related supplies during a time of great need. Unfortunately, such a time may be characterized by significant temporary or permanent problems with the infrastructure of modem life. As a result, various significant mission-threatening problems can arise when seeking to so employ the vehicle during such a time. As a result, it may be desirable to further outfit the vehicle in various other ways to better improve the prospects of the vehicle being able to successfully carry out its supply mission.

This can comprise pre-supplying the vehicle with any of a variety of material that is designed to facilitate at least one of improving survivability of the crew and its cargo, improving the likelihood that the vehicle can complete its designated travel, and so forth. Examples in this regard include, but are certainly not limited to:
body armor (designed to stop at least low caliber small arms fire and of a sturdier variety if desired, including both bulletproof windows, louvered view ports, and armored passenger compartments and/or vehicle compartments);
radiation shielding;
biological/chemical agent protection (including but not limited to the aforementioned positive air pressure capability, decontamination facilities, sealed compartments, and so forth);
medical supplies (including but not limited to first aid supplies as well as first responder emergency medical services supplies such as blood, plasma, automatic external defibrillators, radiation exposure treatments, chemical exposure treatments, antibiotics (including but not limited to medicines such as Tamiflu and the like), and so forth);
spare vehicle parts (including but not limited to mission critical parts relating to the vehicle's drive train, propulsion system, trajectory controls, and so forth);
vehicular maintenance tools;
non-lethal and/or potentially lethal weapons and ammunition; and
supplemental vehicular fuel supplies (carried in on-board auxiliary fuel tanks and/or non-integral fuel containers of choice).

This step can comprise providing more than one vehicle. In many cases it will be desirable to pre-position at least two (and likely more) such vehicles. When providing a plurality of vehicles, their transport modalities may be the same or may differ as desired. By one approach this additional vehicle (or vehicles) can serve as redundant capacity and hence as a backup for the first vehicle. Such redundancy with respect to capacity can aid with assuring, in turn, that cargo transport can be effected notwithstanding the difficult circumstances likely to characterize their transit.

By one approach, if desired, a first vehicle can comprise a cargo-bearing vehicle that is intended to transport the emergency-related supplies while a second (and/or more) vehicle comprises a security vehicle that is intended to accompany the first vehicle when the first vehicle makes its assigned transit. So configured, this security vehicle can be intended to perform such tasks as scouting candidate paths ahead of the first vehicle, following the first vehicle, or other security/protection related tasks as may be strategically or tactically advisable or useful in a given application setting.

Providing such a vehicle can further comprise, if desired, maintaining that vehicle in a substantially constant state of readiness at a predetermined location. This can comprise, in part, optionally maintaining and storing the vehicle in a covered shelter at the predetermined location. This covered shelter can be configured to house a plurality of such vehicles if desired. By one approach the covered shelter may essentially comprise only a roof By another approach the covered sheltered may also comprise one or more walls as well to further aid in protecting the vehicle(s) from the elements, unauthorized access, prying eyes, and so forth.

Much is known in the art regarding construction and maintenance of covered shelters (including both above ground and below ground facilities). Such a construction will usually at least serve to protect the vehicles and their supplies from environmental stress and extremes. In addition to walls and a roof as previously mentioned such a covered shelter may also optionally comprise internal temperature control, lighting, storage facilities, sleeping facilities, food preparation facilities, personal hygiene facilities, and so forth. For present purposes such a covered shelter may also be equipped to provide for water treatment (such as filtering, bacteria removal, and so forth), waste treatment and/or recycling, electrical power generation, and/or air treatment (including but not limited to conditioning, filtering, and so forth). By one approach such a covered shelter can also be equipped with communication facilities including a variety of wireless broadcast capabilities, long-distance two-way communications capabilities, and so forth.

As noted, these options provide a right to purchase portions of a plurality of stockpiled emergency-related supplies in the event of a catastrophic event. This process 100 can therefore further provide for detecting 105 a corresponding catastrophic event trigger (or triggers). By one approach, such a trigger can comprise an objectively or subjectively ascertainable level of likelihood that a given catastrophic event will occur. This approach would permit a potentially affected optionee to make at least some option-based purchases prior to the actual occurrence of the corresponding catastrophic event.

In addition, or in lieu thereof, the effective trigger may comprise the actual occurrence of a given catastrophic event. Such detection may be predicated, if desired, upon a requirement that the catastrophic event be one that persists in substantial form for more than a predetermined period of time (such as one hour, one day, one week, and so forth) or that causes at least a predetermined amount or degree of infrastructure impairment or other objectively or subjectively measurable impact of choice. By this approach option-based purchases may occur in response to an actual occurrence of a catastrophic event.

In response, this process then provides for permitting 106 affected optionees to exercise their respective options to purchase portions of the plurality of various emergency-related supplies to thereby facilitate meeting emergency needs of the affected optionees. This step can be affected in various ways. For example, by one approach, the responsibility can be fully upon the optionee to contact the option facilitator to initiate the purchase, select the particular emergency-related supplies to purchase, select the quantity of items to be purchased, select a particular speed and or mode of delivery, and so forth. By another approach, the option facilitator may have the responsibility (and/or the opportunity) to proactively contact particular optionees to inform such optionees of their right to now exercise their option to make such purchases.

In either case, the means of communicating can be any such approach as may presently exist or that is hereafter developed. This can include in-person communications, traditional wireline-based communications, wireless communications, postal-based communications, overnight service-based communications, and so forth.

Depending upon the terms and conditions of the option itself, this right to purchase may be effected via a one-time purchase or may comprise a plurality of serial purchases. It would also be possible, of course, for the option to stipulate a particular window (or windows) of time during which such purchases could be placed.

As noted above, the emergency-related supplies may comprise consumable items and/or non-consumable items. In either case it is possible that the purchasing optionee may not utilize, at all or in part, at least some of their procured supplies. Such is particularly possible when, for example, the emergency-related supplies are provided a priori a catastrophic event. To accommodate such scenarios, if desired, this process 100 can be further optionally configured to permit accepting 107 a return of unused emergency-related supplies from those optionees who made option-based purchases. This may include unused supplies that are completely unused or that are only partially used as regards consumable items (such as water or fuel supplies, building materials, and so forth) and unused or still-reusable non-consumable items (such as generators, medical ventilators, and so forth).

By one approach, the burden of returning such items could be placed upon the optionee. By another approach, the option service facilitator could arrange to pick up such items (using, for example, the same (or a similar) vehicle as was used to deliver the items in the first instance). If desired, this process 100 could also optionally provide for compensating 108 optionees who return unused or only-partially-used items in this manner. This could comprise, for example, returning part of the optionee's previously proffered purchase price, providing the optionee with a discount applicable to future options, option-based purchases, or the like, and so forth.

So configured, these teachings provide a viable, concrete, and predictable mechanism whereby an interested entity (from individuals to governmental or private enterprises) can acquire for themselves a right to purchase emergency-related supplies at a time when such supplies are likely to be otherwise unavailable to such entities. The cost of procuring and storing relevant items in the first instance is spread out over a base of individuals in a manner that tends to assure that all of these individuals will not simultaneously require those supplies to meet a local emergency situation. By one approach, these teachings can be applied to tend to ultimately minimize the costs for any given entity to acquire emergency-related supplies during a time of need. Such a benefit or result is not required, however, as these teachings are particularly aimed at assuring, in the first instance, that such supplies are available at all to affected optionees.

It will be appreciated that these teachings provide for a highly flexible yet powerfully effective way by which a modem citizen can greatly improve their likelihood of effectively and efficiently surviving and/or recovering from a catastrophic event. These teachings are sufficiently flexible so as to accommodate the needs and desires of a wide-ranging set of potential beneficiaries. Though training and some related activity may be provided and encouraged, in general the beneficiary receives these benefits without being required to make the commitment of time, energy, and expertise that would ordinarily be associated with attaining such a high level of civil security.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in this regard, this option can be combined with a pre-purchase plan. By this approach, an affected entity might have access both to already-purchased stockpiled emergency-related supplies along with the option-based right to purchase additional such supplies.

I claim:

1. A method comprising:
stockpiling a plurality of various emergency-related supplies;
providing consideration-based options to each of a plurality of entities, wherein at least some of the plurality of entities are geographically disparate with respect to one another, to provide a right to purchase portions of the plurality of various emergency-related supplies in the event of a catastrophic event;
in response to at least a likely occurrence of the catastrophic event, permitting an affected one of the entities to exercise their respective option to purchase portions of the plurality of various emergency-related supplies to thereby facilitate meeting emergency needs of the affected one of the entities.

2. The method of claim 1 wherein stockpiling a plurality of various emergency-related supplies comprises stockpiling at least one of:
medical supplies;
fuel supplies;
power source supplies;
nourishment supplies;
hydration supplies;
shelter supplies;
transportation supplies;
personal protection supplies;
breathable air supplies;
electromagnetic pulse recovery supplies;
sanitation supplies.

3. The method of claim 1 wherein stockpiling a plurality of various emergency-related supplies comprises storing the plurality of various emergency-related supplies at a shared location.

4. The method of claim 3 wherein storing the plurality of various emergency-related supplies at a shared location comprises storing the plurality of various emergency-related supplies at a shared location that is substantially centrally disposed with respect to at least most of the plurality of entities.

5. The method of claim 1 wherein providing consideration-based options to each of a plurality of entities to provide a right to purchase portions of the plurality of various emergency-related supplies comprises providing consideration-based options to each of a plurality of entities to provide a right to purchase up to a predetermined quantity of the plurality of various emergency-related supplies.

6. The method of claim 1 wherein the step of permitting an affected one of the entities to exercise their respective option to purchase portions of the plurality of various emergency-related supplies occurs only in response to an actual occurrence of the catastrophic event.

7. The method of claim 1 wherein stockpiling a plurality of various emergency-related supplies comprises stockpiling a plurality of various emergency-related supplies as relate to each of a plurality of different catastrophic events.

8. The method of claim 7 wherein the plurality of different catastrophic events comprise, at least in part:
a natural disaster;
a human-caused disaster.

9. The method of claim 8 wherein the natural disaster comprises at least one of:
an extreme weather-related event;
an extreme geological event;
an extreme space-based collision;
an extreme environmental event;
a pandemic;
economic dislocation.

10. The method of claim 8 wherein the human-caused disaster comprises at least one of:
a nuclear-related event;
an act of war;
an act of terrorism;
a release of a dangerous biological agent;
a release of a dangerous chemical agent;
negligence resulting in civil infrastructure failure.

11. The method of claim 1 wherein stockpiling a plurality of various emergency-related supplies comprises stockpiling at least some consumable emergency-related supplies.

12. The method of claim 1 wherein stockpiling a plurality of various emergency-related supplies comprises stockpiling at least some non-consumable emergency-related supplies.

13. The method of claim 1 further comprising:
accepting a return of unused emergency-related supplies from the affected one of the entities.

14. The method of claim 13 further comprising:
compensating the affected one of the entities in exchange for the unused emergency-related supplies.

15. The method of claim 1 further comprising:
assessing the entities additional consideration in exchange for maintaining the emergency-related supplies.

16. The method of claim 1 further comprising:
providing at least one vehicle;
and wherein permitting an affected one of the entities to exercise their respective option to purchase portions of the plurality of various emergency-related supplies to thereby facilitate meeting emergency needs of the affected one of the entities further comprises using the at least one vehicle to deliver such purchased portions of the plurality of various emergency-related supplies to the affected one of the entities.

17. The method of claim 16 wherein the at least one vehicle comprises at least one of:
an air-borne vehicle;
a terrestrial vehicle;
a water-borne vehicle;
a hovercraft;
an amphibious vehicle;
a pilotless vehicle;
a remotely piloted vehicle.

18. The method of claim 1 wherein stockpiling a plurality of various emergency-related supplies comprises storing the plurality of various emergency-related supplies in a secure facility that is substantially hardened against the catastrophic event.

19. The method of claim 1 wherein the plurality of entities comprises, at least in part, at least one:
individual;
family;
business enterprise;
governmental body.

20. The method of claim 1 wherein the plurality of entities each belongs to a club.

21. The method of claim 20 wherein the club effects the steps set forth in claim 1.

22. The method of claim 1 wherein permitting an affected one of the entities to exercise their respective option to purchase portions of the plurality of various emergency-related supplies comprises assessing charges for the various emergency-related supplies that increase with increasing volume for at least particular ones of the emergency-related supplies.
